(19) United States
(12) Patent Application Publication
(10) Pub. No.: US 2008/0167096 A1
(43) Pub. Date: Jul. 10, 2008

(54) MOBILE PHONE WITH A SLIDE COVER

(76) Inventors: Hsun-Li Huang, Hsinchu City (TW); Shu-Chia Wen, Taipei City (TW); Wen-Ming Wu, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/773,446

(22) Filed: Jul. 5, 2007

(30) Foreign Application Priority Data
Jul. 5, 2006 (TW) 095124479

(51) Int. Cl. H04M 1/00

(52) U.S. Cl. 455/575.4

(57) ABSTRACT

A mobile phone includes a housing, a first module installed on the housing, a second module installed on the housing, and a sliding cover slidably installed on the housing. When the sliding cover slides to a first position, the sliding cover substantially covers the first module and the second module is at least partly exposed, and when the sliding cover slides to a second position, the sliding cover substantially covers the second module and the first module is at least partly exposed.

### BACKGROUND OF THE INVENTION

1. Field of the Invention

The present invention relates to a mobile phone with a slide cover, and more particularly, to a mobile phone with a slide cover that when the sliding cover slides to a first position, the sliding cover covers a first module and a second module is at least partly exposed, and when the sliding cover slides to a second position, the sliding cover covers the second module and the first module is at least partly exposed.

2. Description of the Prior Art

With rapid development of technologies, electronic devices are widely utilized in various fields. For instance, the utilization of a convenient and light mobile phone has become a common way of communication in daily lives. With these mobile devices, people can easily exchange or share information, experiences, and opinions. Mobile phones have progressed tremendously in recent years. Various types of mobile phones are continuously being developed and the demand is still increasing. Together with communication quality, appearance and size-reduction, the ability to provide a user with a more convenient operating environment is also a major concern when designing a mobile phone.

In opening design of the mobile phone in the market, part of the opening design of the mobile phone utilizes a folder-type construction. A folder-style mobile phone is divided into two parts. One part contains a display panel and the other part contains a keypad. The two parts are connected with a hinge and other fixing components. Compared with a bar-type mobile phone, the folder-type mobile phone has advantages of a small size in a close status, preventing keypads being triggered inadvertently, and so on. However it is a pity that there is no extra function applied on an upper module (display module) when closing the upper module and a lower module (main body) of the conventional folder-type mobile phone.

### SUMMARY OF THE INVENTION

It is therefore a primary objective of the claimed invention to provide a mobile phone with a slide cover for solving the above-mentioned problem.

According to the claimed invention, a mobile phone includes a housing, a first module installed on the housing, a second module installed on the housing, and a sliding cover slidably installed on the housing. When the sliding cover slides to a first position, the sliding cover substantially covers the first module and the second module is at least partly exposed, and when the sliding cover slides to a second position, the sliding cover substantially covers the second module and the first module is at least partly exposed.

According to the claimed invention, a mobile phone includes a first component, and a second component connected to the first component. The second component includes a housing, a first module installed on the housing, a second module installed on the housing, and a sliding cover slidably installed on the housing. When the sliding cover slides to a first position, the sliding cover substantially covers the first module and the second module is at least partly exposed, and when the sliding cover slides to a second position, the sliding cover substantially covers the second module and the first module is at least partly exposed.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a folder-type mobile phone of the present invention.

FIG. 2 is a diagram of the folder-type mobile phone of the present invention.

FIG. 3 is a schematic drawing of the folder-type mobile phone when a sliding cover slides to a first position of the present invention.

FIG. 4 is a schematic drawing of the folder-type mobile phone when the sliding cover slides to a second position of the present invention.

FIG. 5 and FIG. 6 are exploded diagrams of the sliding cover and a second housing of the folder-type mobile phone of the present invention.

FIG. 7 is a diagram illustrating the sliding cover slides to the first position of the present invention.

FIG. 8 is a diagram illustrating the sliding cover slides to the second position of the present invention.

FIG. 9 is a diagram illustrating sliding components slide to the first position inside slots of the present invention.

FIG. 10 is a diagram illustrating the sliding component slides to the second position inside the slots of the present invention.

### DETAILED DESCRIPTION

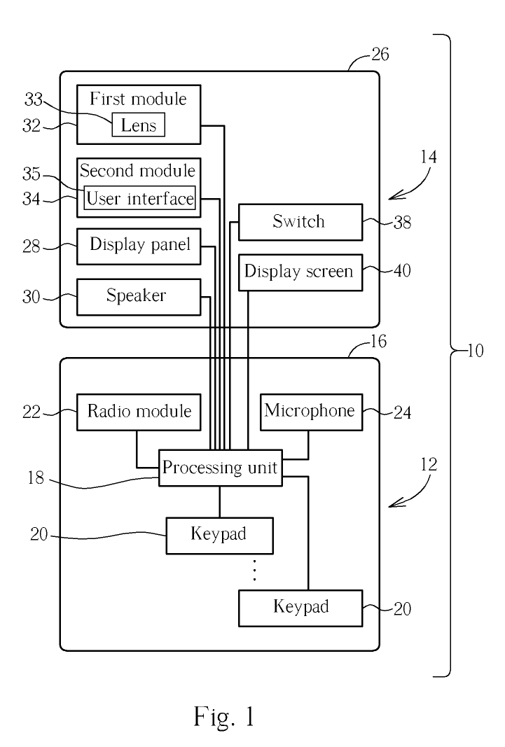

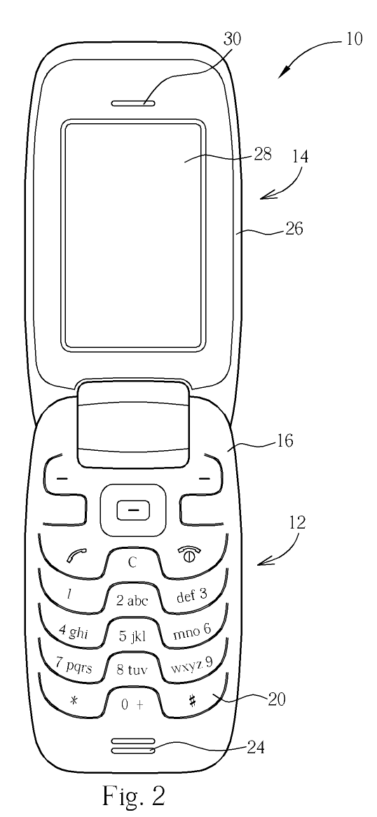

Please refer to FIG. 1 and FIG. 2. FIG. 1 is a functional block diagram of a folder-type mobile phone 10 of the present invention. FIG. 2 is a diagram of the folder-type mobile phone 10 of the present invention. The folder-type mobile phone 10 includes a first component 12 and a second component 14. The first component 12 is a main body of the folder-type mobile phone 10, and the second component 14 is a display module of the folder-type mobile phone 10. The first component 12 includes a first housing 16, a processing unit 18 installed inside the first housing 16 for controlling operation of the folder-type mobile phone 10, and a plurality of keypads 20 installed on the first housing 16 for inputting control signals to the processing unit 18. The user can also make a phone call by dialing a telephone number using the keypads 20. The first component 12 further includes a radio module 22 installed in the first housing 16 and electrically connected to the processing module 18 for receiving radio signals to generate corresponding communication signals and sending them to the processing module 18 as well as outputting data from the processing module 18 wirelessly, and a microphone 24 electrically connected to the processing module 18 for converting real sound into audio signals and sending them to the processing module 18. The second component 14 is pivoted to the first component 12 in a foldable manner. The second component 14 includes a second housing 26, a display panel 28 installed inside the housing 26 and electrically connected to the processing unit 18 via a cable, such as a flexible printed board, for displaying images corresponding to data transmitted from the processing unit 18, and a speaker 30 installed in the second housing 26 and electrically connected to the processing module 18 for converting the data from the processing module 18 into real sound. The second component 14 further includes a first module 32 electrically connected to the processing unit 18 and installed on the second housing 26, a second module 34 electrically connected to the processing unit 18 and installed on the second housing 26, a sliding cover 36 installed on the second housing 26 in a slidable manner, a switch 38 installed inside the second housing 26 and electrically connected to the processing unit 18 for outputting a switch signal to the processing unit 18 when the switch 38 is contacted by the sliding cover 36, and one of the first module 32 and the second module 34 is selectively enabled by the switch signal 38., and a display screen 40 installed below the sliding cover 36 and electrically connected to the processing unit 18 for displaying images corresponding to data transmitted from the processing unit 18. For example, the display screen 40 can display time data, information of using the first module 32 or the second module 34, such as the name of the playing song, and so on. The first module 32 can be a camera module and includes a lens 33 for receiving light. The second module 34 can be a multimedia file playing module, such as a MP3 playing module, and the second module 34 includes a user interface 35 for providing a user to operate the second module 34 as a module keypad. The sliding cover 36 includes a hole 361 to expose the display screen 40 when the sliding cover 36 is disposed at one of the first position and the second position. The hole 361 is larger than an opening for locating the display screen 40 on the second housing 26 so as to expose the display screen 40 anytime.

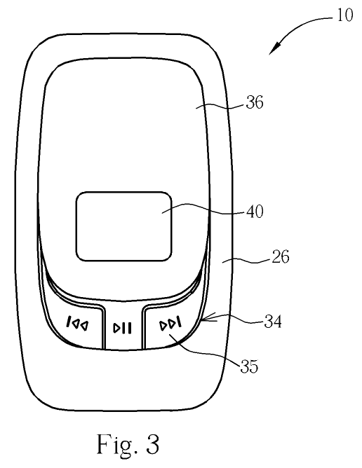

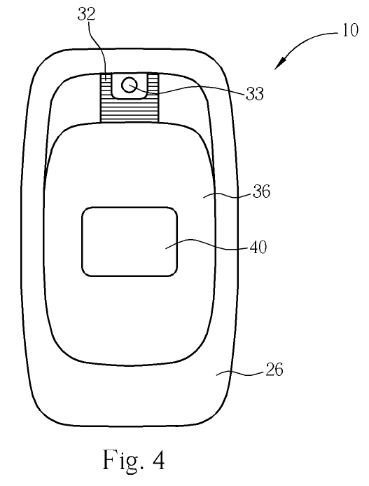

Please refer to FIG. 3 and FIG. 4. FIG. 3 is a schematic drawing of the folder-type mobile phone 10 when the sliding cover 36 slides to a first position of the present invention. FIG. 4 is a schematic drawing of the folder-type mobile phone 10 when the sliding cover 36 slides to a second position of the present invention. When the sliding cover 36 slides to a first position, the sliding cover 36 covers the lens 33 of the first module 32 and can not cover the user interface 35 of the second module 34 completely so that the second module 34 is at least partly exposed. The user can utilize the function of the second module 34, such as playing MP3 files. The sliding cover 36 can protect the first module 32, such as protecting the lens 33 of the first module 32 from dirt and harm. When the sliding cover 36 slides to the second position, the sliding cover 36 covers the second module 34 and can not cover the first module 32 completely so that the first module 32 is at least partly exposed. The user can utilize the function of the first module 32, such as taking pictures. The sliding cover 36 can protect the second module 34, such as preventing the user interface 35 of the second module 34 from being triggered inadvertently.

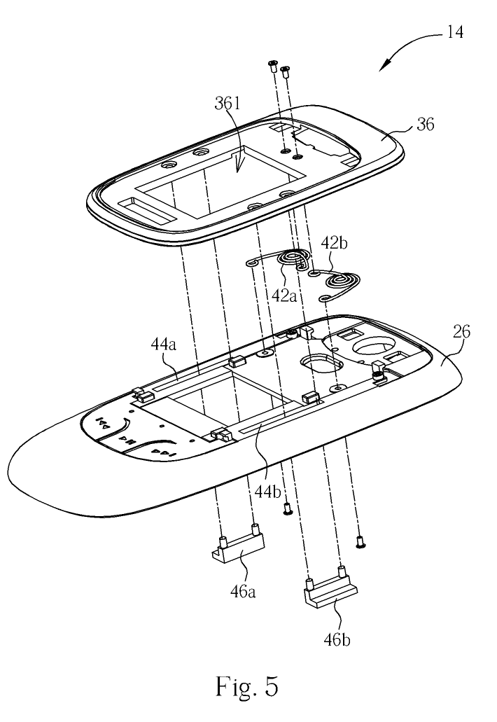

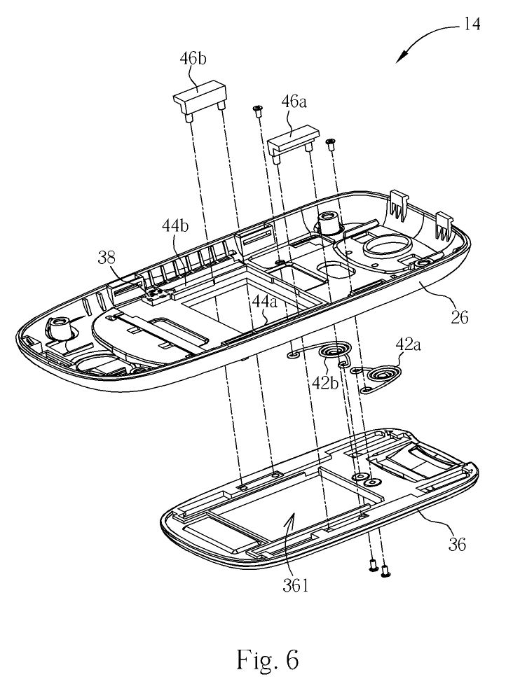

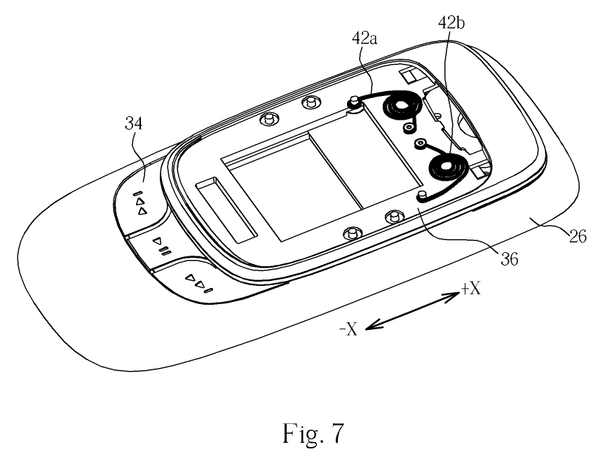

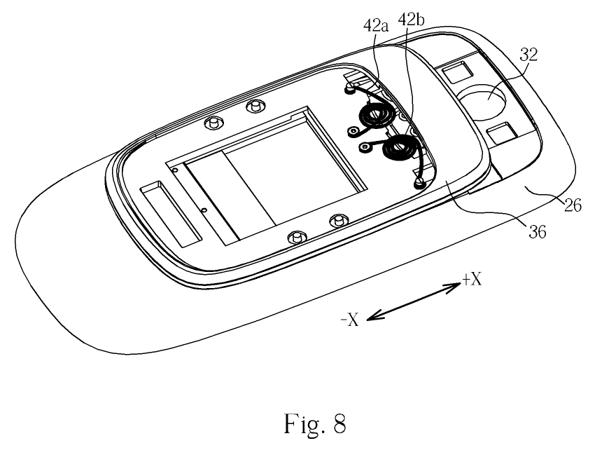

Please refer to FIG. 5 and FIG. 6. FIG. 5 and FIG. 6 are exploded diagrams of the sliding cover 36 and the second housing 26 of the folder-type mobile phone 10 of the present invention. The second component 14 further includes two elastic components 42a, 42b. Two ends of the elastic components 42a, 42b are connected to the second housing 26 and the sliding cover 36 respectively. The elastic components 42a, 42b can be deformed by external force. The elastic components 42a, 42b provide elastic forces to the sliding cover 36 to push the sliding cover 36 toward the first position shown in FIG. 3 or the second position shown in FIG. 4 after the sliding cover 36 slides at a stroke. The elastic components 42a, 42b can be springs, such as torsional springs, for controlling relative movement of the sliding cover 36 and the second housing 26. The folder-type mobile phone 10 can be semi-automatically opened and closed based on the inflection point of the torsional springs. Please refer to FIG. 7 and FIG. 8. FIG. 7 is a diagram illustrating the sliding cover 36 slides to the first position of the present invention. FIG. 8 is a diagram illustrating the sliding cover 36 slides to the second position of the present invention. In order to use the second module 34, a user can apply an external force in +X direction. Once the elastic components 42a, 42b receives sufficient compression and its curvature reaches the inflection point, the inherent elasticity of the elastic components 42a, 42b continues to provide a force in +X direction for pushing the sliding cover 36 to the first position. Similarly, in order to use the first module 32, a user can apply an external force in −X direction. Once the elastic components 42a, 42b receives sufficient compression and its curvature reaches the inflection point, the inherent elasticity of the elastic components 42a, 42b continues to provide a force in −X direction for pushing the sliding cover 36 to the second position.

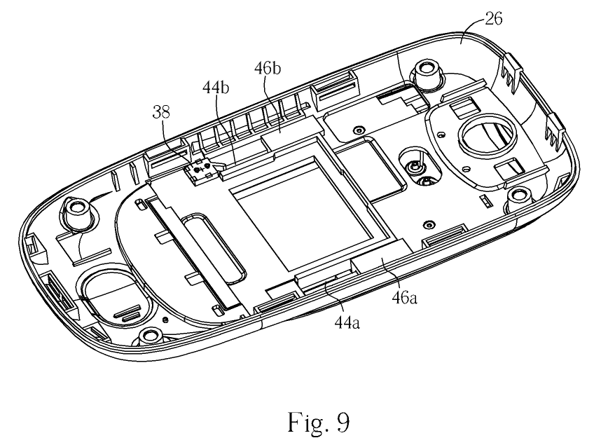

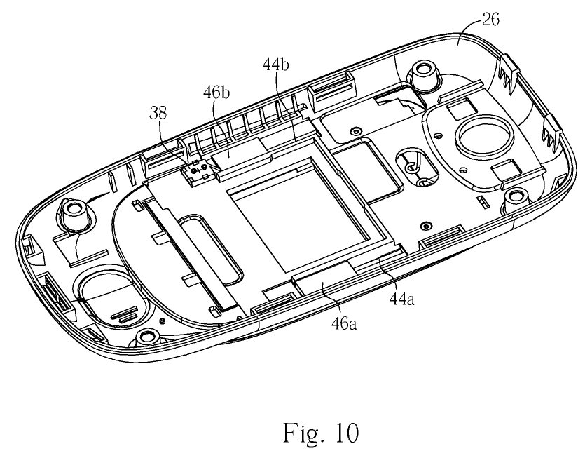

Please refer to FIG. 5 and FIG. 6. Two slots 44a, 44b are disposed on the second housing 26, and the sliding cover 36 includes two sliding components 46a, 46b installed inside the slots 44a, 44b in a slidable manner so that the sliding cover 36 can slide on the second housing 26. The switch 38 can disposed on one end of either the slots 44a, 44b. When the sliding component 46a, 46b of the sliding cover 36 slides to the end of the slots 44a, 44b and triggers the switch 38, the switch 38 can output a switch signal to the processing unit 18 for turning on or turning off the first module 32 or the second module 34. For example, please refer to FIG. 9 and FIG. 10. FIG. 9 is a diagram illustrating the sliding components 46a, 46b slide to the first position inside the slots 44a, 44b of the present invention. FIG. 10 is a diagram illustrating the sliding components 46a, 46b slide to the second position inside the slots 44a, 44b of the present invention. The switch 37 is disposed on the bottom of the slot 44b. When the sliding component 46b of the sliding cover 36 slides to the top of the slot 44b, the sliding component 46b can not trigger the switch 38 so that the first module 32 is disabled and the second module 34 is enabled. When the sliding component 46b of the sliding cover 36 slides to the bottom of the slot 44b, the sliding component 46b triggers the switch 38 and the switch 38 outputs a switch signal to the processing unit 18 so that the first module 32 is enabled and the second module 34 is disabled. Therefore, the operating mode of the first module 32 and the second module 34 can be switched by sliding the sliding cover 36. Similarly, the switch 37 can be disposed on the top of the slot 44b. When the sliding component 46b of the sliding cover 36 slides to the bottom of the slot 44b, the sliding component 46b can not trigger the switch 38 so that the second module 34 is disabled and the first module 32 is enabled. When the sliding component 46b of the sliding cover 36 slides to the top of the slot 44b, the sliding component 46b triggers the switch 38 and the switch 38 outputs a switch signal to the processing unit 18 so that the second module 34 is enabled and the first module 32 is disabled. Therefore, the operating mode of the first module 32 and the second module 34 can be switched by sliding the sliding cover 36.

In addition, the first module 32, the second module 34, and the sliding cover 36 can be installed on a rear side (the side not disposing the keypads 20) of the first module 12. The operating principle and structure is the same as that mentioned above. The detail description is omitted. Furthermore, the mechanism of the present invention can apply in not only the folder-type mobile phone but also a sliding-type mobile phone, a bar type mobile phone, and so on. For example, the first module, the second module, and the sliding cover can be installed on a rear side of a main body of the sliding-type mobile phone or on a top side of a display module of the sliding-type mobile phone. The first module, the second module, and the sliding cover also can be installed on a rear side of the bar type mobile phone. The operating principle and structure is the same as that mentioned above. The detail description is omitted.

In contrast to the conventional mobile phone, the mobile phone of the present invention can switch operating modes of the camera module on the display module and the MP3 playing module by sliding the sliding cover when the display module is closed with the main body. Furthermore, the sliding cover can protect the camera module and the MP3 playing module, such as protecting a lens of the camera module from dirt and harm or preventing keypads of the MP3 playing module from being triggered inadvertently. The present invention provides additional functions for man-machine interface of the mobile phone.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A mobile phone comprising:
a housing;
a first module installed on the housing;
a second module installed on the housing; and
a sliding cover slidably installed on the housing;
wherein when the sliding cover slides to a first position, the sliding cover substantially covers the first module and the second module is at least partly exposed, and when the sliding cover slides to a second position, the sliding cover substantially covers the second module and the first module is at least partly exposed.

2. The mobile phone of claim 1 wherein the housing comprises a slot and the sliding cover comprises a sliding component slidably connected with the slot.

3. The mobile phone of claim 1 further comprising a switch installed on the housing for outputting a switch signal when the switch is contacted by the sliding cover, and one of the first module and the second module is selectively enabled by the switch signal.

4. The mobile phone of claim 1 further comprising an elastic component disposed between the housing and the sliding cover for providing an elastic force to push the sliding cover toward one of the first position and the second position.

5. The mobile phone of claim 4 wherein the elastic component is a spring, and the spring is compressed when the sliding cover disposed between the first position and the second position, and released when the sliding cover disposed at one of the first position and the second position.

6. The mobile phone of claim 1 wherein the first module is a camera module, the camera module comprises a lens, and the second module is enabled when the sliding cover slides to the first position to protect the lens.

7. The mobile phone of claim 1 wherein the second module comprises a user interface, and the first module is enabled when the sliding cover slides to the second position to cover the user interface.

8. The mobile phone of claim 7 wherein the second module is a multimedia file playing module, the user interface is a module keypad, and the first module is enabled when the sliding cover slides to the second position to cover the module keypad.

9. The mobile phone of claim 1 further comprising a display screen installed below the sliding cover for displaying images, and the sliding cover comprises a hole to expose the display screen when the sliding cover disposed at either one of the first position and the second position.

10. A mobile phone comprising:
a first component; and
a second component connected to the first component, the second component comprising:
a housing;
a first module installed on the housing;
a second module installed on the housing; and
a sliding cover slidably installed on the housing wherein when the sliding cover slides to a first position, the sliding cover substantially covers the first module and the second module is at least partly exposed, and when the sliding cover slides to a second position, the sliding cover substantially covers the second module and the first module is at least partly exposed.

11. The mobile phone of claim 10 wherein the housing comprises a slot and the sliding cover comprises a sliding component slidably connected with the slot.

12. The mobile phone of claim 10 wherein the second component further comprises a switch installed on the housing for outputting a switch signal when the switch is contacted by the sliding cover, and one of the first module and the second module is selectively enabled by the switch signal.

13. The mobile phone of claim 10 wherein the second component further comprises an elastic component disposed between the housing and the sliding cover for providing an elastic force to push the sliding cover toward one of the first position and the second position.

14. The mobile phone of claim 13 wherein the elastic component is a spring, and the spring is compressed when the sliding cover disposed between the first position and the second position, and released when the sliding cover disposed at one of the first position and the second position.

15. The mobile phone of claim 10 wherein the first module is a camera module, the camera module comprises a lens, and the second module is enabled when the sliding cover slides to the first position to protect the lens.

16. The mobile phone of claim 10 wherein the second module comprises a user interface, and the first module is enabled when the sliding cover slides to the second position to cover the user interface.

17. The mobile phone of claim 16 wherein the second module is a multimedia file playing module, the user interface is a module keypad, and the first module is enabled when the sliding cover slides to the second position to cover the module keypad.

18. The mobile phone of claim 17 wherein the second component further comprises a display panel installed inside the housing for displaying images.

19. The mobile phone of claim 10 wherein the second component further comprises:
a processing unit installed inside the housing for controlling operation of the mobile phone; and
a plurality of keypads installed on the housing for inputting control signals to the processing unit.

20. The mobile phone of claim 10 further comprising a display screen installed below the sliding cover for displaying images, and the sliding cover comprises a hole to expose the display screen when the sliding cover disposed at either one of the first position and the second position.
